(19) United States
(12) Patent Application Publication
(10) Pub. No.: US 2017/0336300 A1
(43) Pub. Date: Nov. 23, 2017

(54) MICROTOME

(71) Applicants: Herbert LUTTENBERGER, Sankt Veit a.d. Glan (AT); Robert TOMIC, Graz (AT)

(72) Inventors: Herbert LUTTENBERGER, Sankt Veit a.d. Glan (AT); Robert TOMIC, Graz (AT)

(21) Appl. No.: 15/598,878

(22) Filed: May 18, 2017

(30) Foreign Application Priority Data
May 19, 2016 (AT) A 251/2016

(51) Int. Cl. G01N 1/06; H04N 7/18

(52) U.S. Cl. CPC G01N 1/06; H04N 7/183; G01N 2001/066; G01N 2001/068

(57) ABSTRACT

The preparation holding device of a microtome can be pivoted via a ball head. To pivot the preparation holding device, actuators are assigned to the latter as drives. A camera and laser diodes are arranged on the knife carrier of the microtome to detect the shape and positions of the preparation.

### BACKGROUND OF THE INVENTION

### Field of the Invention

The invention relates to a microtome with the features of the introductory part of claim 1.

### Description of the Related Art

Known microtomes have a number of operating elements that are arranged at different places in the microtome and at a distance from one another and with which the microtome is adjusted, the function of the microtome is selected, and the operation of the microtome is controlled.

Thus, using operating elements, the motions of the preparation holding device can be triggered to move from their readiness position into their operating position, in which the preparation is assigned to the knife of the microtome. Also, the extent of the feed stroke, i.e., the stroke of the preparation holding device before the individual cutting processes, is controlled and adjusted by operating elements.

Additional operating elements are used to match the speed, at which cutting processes follow one another, to the preparation to be cut.

In the case of known microtomes, it is often also necessary to produce the motions before, during, and after cutting processes by actuating a crank handle when no power drive is provided for this purpose.

The crank handle that is provided in known microtomes is disruptive (takes up a lot of space!) and is not without its risks, since the crank handle also moves when cutting processes are carried out by motor means, e.g., in an automated operation.

Because of the number of operating elements (“buttons” and “switches”) arranged at different places in the microtome, which operating elements an operator accesses and must activate when the microtome is used, and with allowance for the fact that sections, in particular in hospitals, must be produced under time pressure, i.e., quickly and in large numbers, there is considerable strain and stress on the person who operates the microtome to produce sections. Operating errors of the microtome and sections that are consequently unusable can result.

A microtome of the Hess Consult GmbH (Walldorf/FRG) is known, in which some of the functions of the microtome can be actuated using a knob that can be pivoted and rotated in several directions and that is arranged on the side in the housing of the microtome. For implementing the actual cutting processes in order to produce sections of the preparation, in which the preparation holding device is moved downward relative to the knife, the actuation of a crank handle that is arranged on the side in the housing of the known microtome of the Hess Consult GmbH is necessary. Additional functions of the microtome of the Hess Consult GmbH are actuated via a touch display and using another rotating and pressing knob. Thus, for operating the known microtome of the Hess Consult GmbH, several operating elements arranged at a distance from one another are provided, which elements have to be actuated independently of one another in order to actuate the horizontal back-and-forth motion of the object head (preparation holding device), the vertical cutting motion, the speed, the start-/stop-/braking function, the electrical hand wheel function, and finally the prompting and automatic start-up of the memo position.

In the known microtome of the Hess Consult GmbH, the knife carrier is arranged in an adjustable manner in the housing of the microtome. Thus, the position of the knife can be adjusted relative to the preparation. The arrangement of the knife carrier on rails is not used only to adjust the knife carrier to the knife but rather it also makes it possible that the knife carrier be taken off for cleaning and for replacing the knife of the microtome. During production of sections, however, the knife carrier is not adjusted, but rather the preparation holding device is moved forward after each cutting process by one step (section thickness), as is common in the case of known microtomes.

A problem in the case of known microtomes is also the fact that the preparation holding device is pushed forward after each cutting process and before a subsequent cutting process. As a result, the distance between the preparation and the guide of the preparation holding device is increasingly larger, which has the effect of a disadvantageous decrease in the precision of the position of the preparation relative to the knife and produces inexact sections. In this case, it is to be taken into consideration that the thickness of the sections, in particular in the case of sections of human tissues, which are required in medicine, is on the order of magnitude of a few microns.

In the case of microtomes, it is also known to adjust the orientation of the preparation in the preparation holding device by hand to the optimal orientation of the preparation by the actuation of adjusting screws, which are provided on the preparation holding device. This adjustment of the orientation of the preparation is essential in particular in the case of preparations made from human tissue, which are embedded in a body from a mixture (e.g., PARAPLAST” of Sigma Aldrich) that consists of paraffin and a plastic (e.g., polyisobutylene), which is a grid on one side (the reverse), since virtually always, only “a little” tissue is available, and nevertheless matching and suitable sections are necessary for the microscopic studies of the sections. Also, the loss of preparation during production (“first cut”) of the outside surface of the preparation that matches the first section is to be small.

### SUMMARY OF THE INVENTION

The object of the invention is to avoid the above-described drawbacks of microtomes by the orientation of the preparation in the preparation holding device being simplified.

This object is achieved with a microtome that has the features of claim 1.

Preferred and advantageous configurations of the microtome according to the invention are subjects of the subclaims.

Since in the microtome according to the invention, at least one sensor that detects the position of the preparation and a drive for adjusting the position of the preparation by adjusting the preparation holding device are assigned to the preparation holding device, the preparation is automatically optimally oriented without manual adjustment having to be performed.

Because of the possibility provided with the microtome according to the invention of orienting the preparation, not only are the preparation discards, which accumulate during the first cut of the same, kept small, since the front side of the preparation can be oriented as well as possible, but also there is the advantage that the knife is protected and that the time until the first usable section is obtained is shortened.

In a preferred embodiment, the preparation holding device of the microtome according to the invention is held via a ball-head-like mount. This allows an orientation of the preparation holding device that is largely free in terms of multiple degrees of freedom and directions by pivoting.

In one embodiment, a camera, preferably an HD camera, is provided for detecting the front side of the preparation that is inserted into the preparation holding device. This camera can be arranged on the knife carrier, directed toward the preparation holding device. This camera detects the preparation, whereby the preparation carrier is moved up and down with the preparation. The thus detected data on the preparation are stored.

When this is completed, the preparation is scanned by, for example, laser diodes, arranged on the knife carrier and close to the preparation carrier, in particular at various angles (variously-oriented planes in which it is scanned). In this case, the camera detects the reflected laser light. The thus detected data on the position of the preparation relative to the knife carrier are also stored.

Based on the thus detected data on the position and shape of the front side of the preparation, the preparation holding device and preferably also the knife in the knife carrier are oriented and adjusted in such a way that the preparation discards in the first cutting process (first cut) are small.

### BRIEF DESCRIPTION OF THE DRAWINGS

Further details and features of the invention follow from the description below of a preferred embodiment of a microtome according to the invention. Here:

FIG. 1 shows a microtome in oblique view,

FIG. 2 shows the microtome from FIG. 1 in side view,

FIG. 3 shows a detail of the microtome in the area of the preparation holding device,

FIG. 4 shows a detail of the microtome in the area of the knife carrier,

FIG. 5 shows a control lever,

FIG. 6 shows a schematic arrangement for adjusting the preparation holding device in oblique view, and

FIG. 7 shows the arrangement of FIG. 6 with an assigned preparation holding device.

### DESCRIPTION OF THE PREFERRED EMBODIMENTS

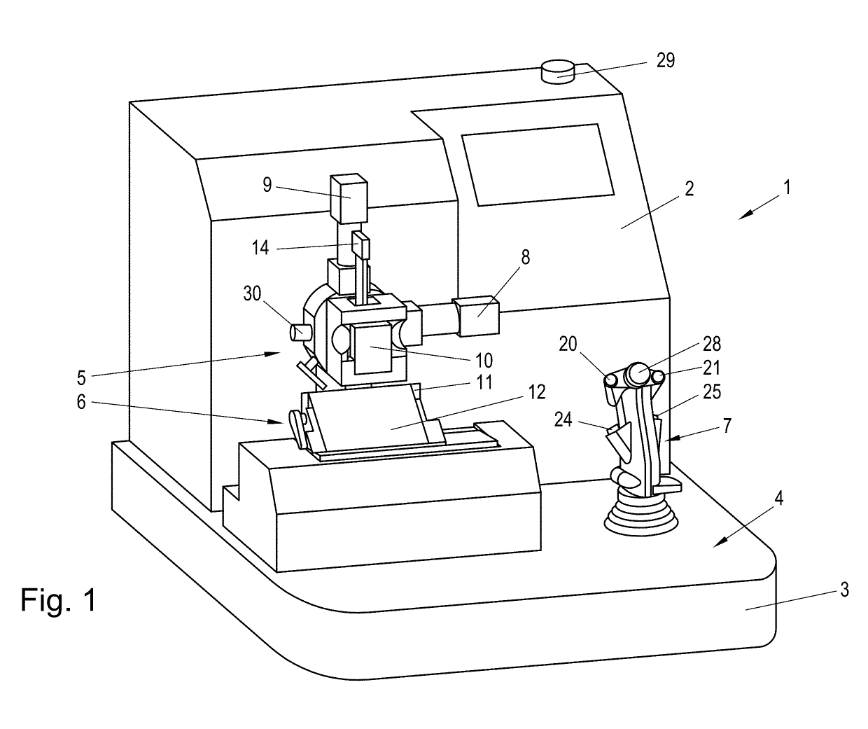

A microtome 1 that is shown in FIGS. 1 to 5 comprises a housing 2, in which additional components of the microtome according to the invention, such as drives and the like, are housed, and a base plate 3.

The microtome 1 has a preparation holding device 5, which projects forward from the housing 2 and extends above a front area 4 of the base plate 3 of the microtome 1. The drive for the motion of the preparation holding device 5 toward the base plate 3 (downward) and away from the base plate 3 (upward) is housed in the housing 2. In the case of the microtome 1 according to the invention—unlike in the case of the known microtomes—the preparation holding device 5 cannot be adjusted in a direction that is parallel to the base plate 3 (horizontal).

A knife carrier 6 is arranged in the front area 4 of the base plate 3 of the microtome 1.

In addition, a control lever 7 in the form of a joystick is provided in the front area 4 of the base plate 3 of the microtome 1 to the right from the knife carrier 6 in the embodiment shown.

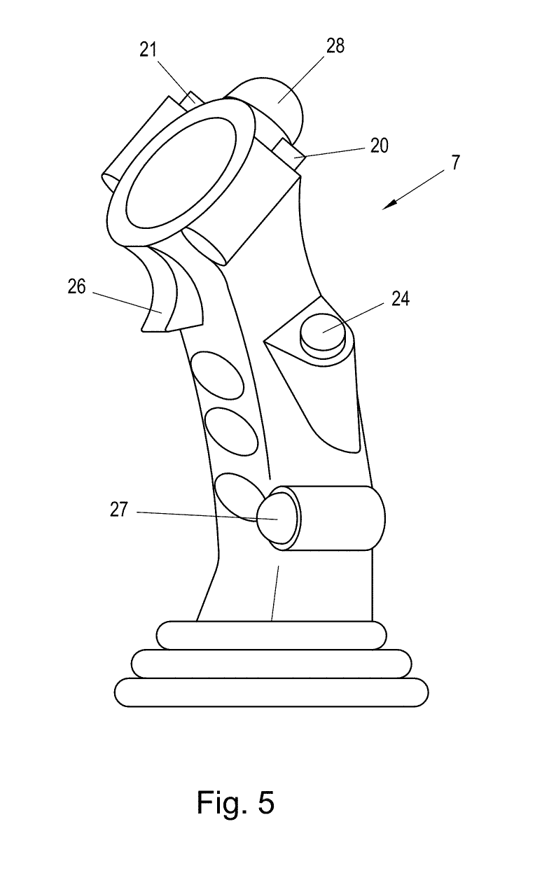

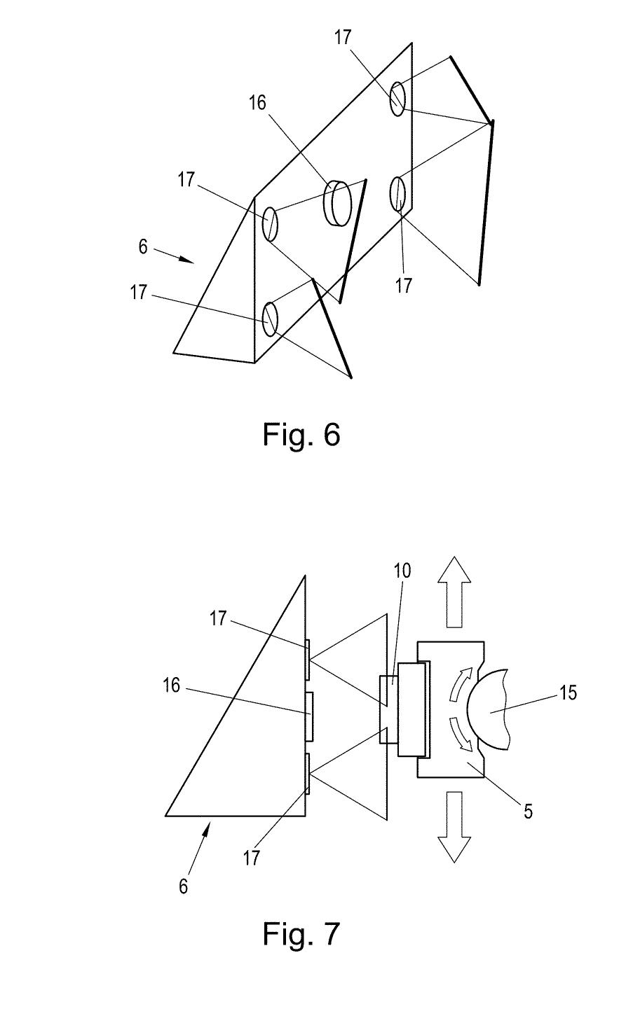

In the case of the microtome 1 according to the invention, the preparation holding device 5 can be adjusted using drives 8 and 9, as is still to be explained in detail further below with reference to FIGS. 5 and 6.

When a cutting process is executed to produce a section of the preparation 10, which is clamped in the preparation holding device 5, the preparation 10 is moved downward onto the front area 4 of the base plate 3 by lowering the preparation holding device 5, whereby the knife 11, by the relative motion, creates a section that comes to lie on a contact area 12 of the knife carrier 6.

In the case of the microtome 1 according to the invention, before and after the creation of a section, the knife carrier 6 with the knife 11 moves into the position that is appropriate for the desired thickness of the section that is to be produced.

After each cutting process, the knife 11 is moved back a short way (e.g., 20 μm) by moving the knife carrier 6, and then pushed forward again by the desired section thickness in addition by the previously-indicated return stroke. The preparation 10 is prevented from grinding on the knife 11 when the preparation holding device 5 is moved back (lifted up) into the starting position by the return stroke of the knife 11 after each cutting process since, based on experience, the preparation 10 expands somewhat after each cutting process.

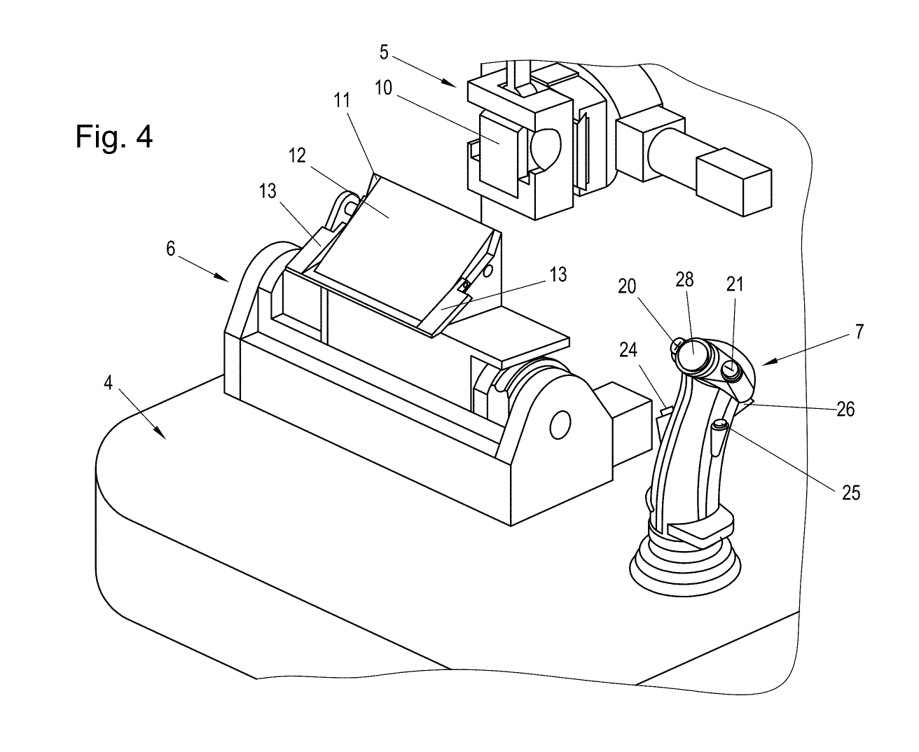

For the adjustment of the knife carrier 6, this guide rail 13 that is arranged in the front area 4 of the base plate 3 (base) of the microtome 1, as indicated in FIG. 4, can be moved, and therefore drives, not shown, are assigned to the knife carrier 6.

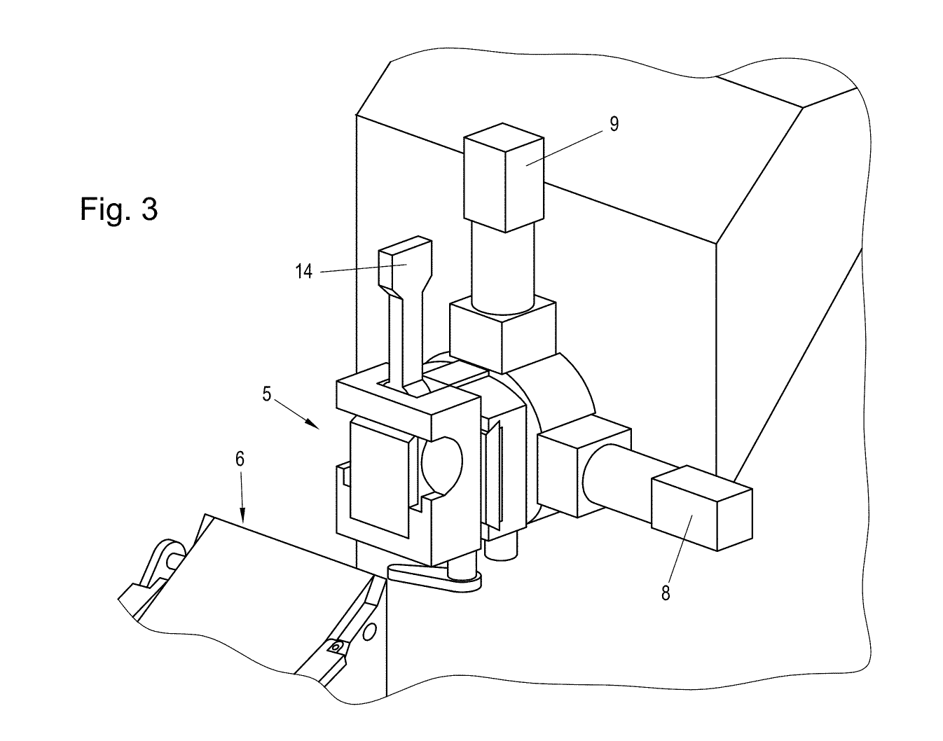

The preparation holding device 5, which is fastened to the arm of the object by a screw 30 and which is shown in greater detail in FIG. 3, comprises, as is common for microtomes per se, a lever 14 for the gripping of the body in which the preparation 10 is embedded. In addition, on the preparation holding device 5, two holding pins that are equipped with projections (handles) (one points straight downward; the other points obliquely downward) are provided, which pins secure the front part of the preparation holding device 5. After loosening the holding pins, an adapter for the preparation 10 that is inserted into the preparation holding device 5 can be removed and exchanged for another adapter.

The preparation holding device 5 is mounted over a ball head 15 so that it can be pivoted by the drives 8 and 9, ensuring that the preparation 10 can be brought into the optimal position for generating sections relative to the knife 11 on the knife carrier 6.

The arrangement, which actuates the drives 8 and 9 for the adjustment of the preparation holding device 5, so that the latter move (pivot) the preparation holding device 5 by pivoting the preparation holding device 5 into the above-mentioned optimal position, comprises, for example on the side of the knife carrier 6 that faces the preparation holding device 5, a camera 16, in particular an HD camera. The camera 16 detects the preparation 10, whereby the preparation holding device 5 is moved up and down with the preparation 10, so that the camera 16 can detect (“scan”) the entire front side of the preparation 10. The data detected by the camera 16 are stored. As soon as the data, which the camera 16 has detected, are stored, the preparation 10 is scanned again. To this end, the arrangement for detecting the preparation 10 in the embodiment comprises four laser diodes 17, which are arranged around the camera 16 on the knife carrier 6. As shown in FIG. 6, the laser diodes 17 are oriented at various angles so that by scanning by means of laser diodes 17 in different planes, the shape of the front side of the preparation 10 and the body, in which the preparation 10 is embedded, is reliably detected. The camera 16 detects the reflected laser light and stores the thus detected data on the position of the preparation 10 relative to the knife carrier 6.

Based on the thus detected data on the position and shape of the front side of the preparation 10 and the body, in which the preparation 10 is embedded, the preparation holding device 5 is oriented and adjusted by the drives 8 and 9 (actuators) assigned to it by pivoting around the central point of the ball head 15, via which the preparation holding device 5 is held, in such a way that the discards from the preparation 10 after the first cutting process (first cut) are as small as possible.

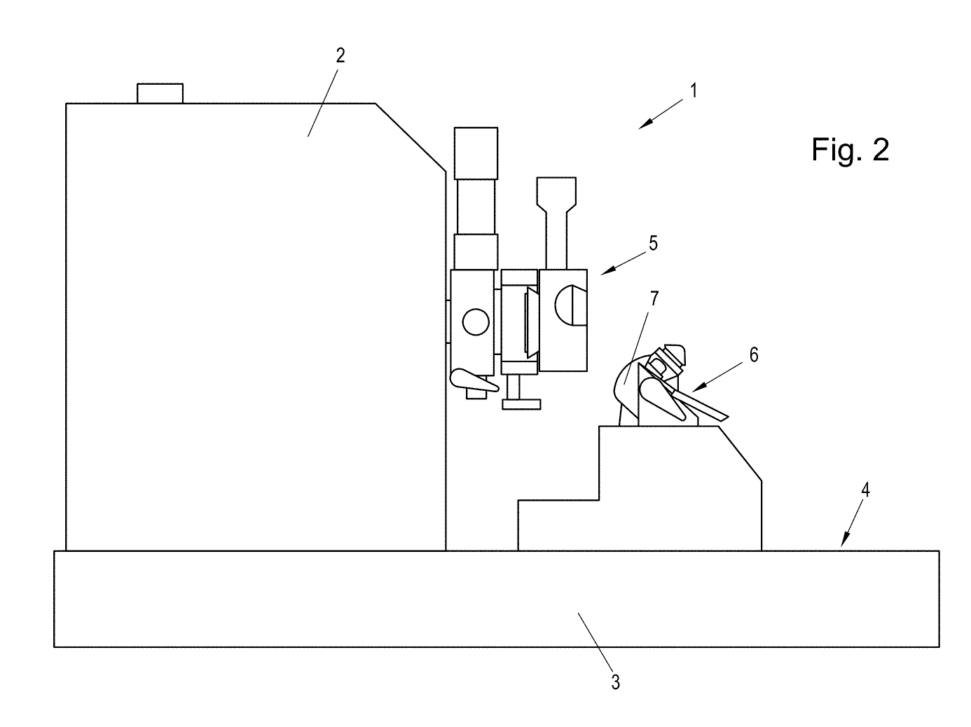

For the operation of the microtome 1, the control lever 7, which is designed like a joystick, is provided instead of the otherwise common control knobs and crank handles. The control lever 7 can be pivoted (tilted) around a pivoting center arranged in the area of the base plate 3 in a plane perpendicular to the base plate 3. The plane in which the control lever 7 can pivot is oriented, for example, perpendicular to the image plane of FIG. 1 or parallel to the image plane of FIG. 2. In addition, the control lever 7 can be pivoted (tilted) in a plane that is oriented perpendicular to the image plane of FIG. 2.

The functions of the control lever 7 are the following:

By pivoting the control lever 7 away from the housing 2 of the microtome 1, the operating element, which actuates the speed at which the microtome 1 works, is actuated in such a way that the speed is reduced in an infinitely variable manner. The further the control lever 7 is pivoted away from the housing 2, the more the speed at which the microtome 1 works is reduced.

When the control lever 7 is pivoted toward the housing 2, the operating element, which actuates the speed at which the microtrome 1 works, is actuated in such a way that the speed is increased. The further the control lever 7 is pivoted toward the housing 2, the more the speed at which the microtome 1 works is increased.

The operating speed, i.e., the speed at which sections are created (cutting speed), can thus be adjusted in an infinitely variable manner to the optimal value in each case, whereby by means of the operating lever 7, simultaneous motions of the knife carrier 6 (feed stroke and return stroke of the knife 11) can be triggered, by having buttons that are provided for this purpose on the control lever 7, to which switches are assigned, be actuated (depressed).

To trigger the motions of the knife carrier 6 (feed stroke toward the preparation holding device 5 and return stroke away from the preparation holding device 5), buttons 20 and 21 are provided on the free end of the control lever 7.

The changing of the cutting speed can be carried out by pivoting the control lever 7 toward the housing 2 or away from the housing 2 simultaneously to the adjustment of the knife carrier 6 (feed stroke and return stroke), by the button 20 or 21 also being actuated during pivoting of the control lever 7.

The speed at which the knife carrier 6 is moved, when it performs its motion toward the preparation holding device 5 and away from the latter, can be adjusted (in particular in an infinitely variable manner) by the above-described pivoting of the control lever 7.

To adjust the section thickness, buttons 24 and 25 are provided on the side of the control lever 7. The adjustment of the section thickness can be done simultaneously to the change in the cutting speed. This is done, for example, in such a way that the button 24 “+” is actuated for increasing the section thickness or the button 25 “−” is actuated for decreasing the section thickness, optionally simultaneously to the pivoting of the control lever 7 to change the cutting speed.

By the actuation of another button 26, which is provided on the side of the control lever 7 facing the housing 2, the first cut of the preparation 10 (e.g., 15 μm that is programmable in an infinitely variable manner on the microtome 1) can be selected.

Another button 27 is provided on the side below on the control lever 7, with which button it is possible to switch to automatic operation.

Finally, an emergency stop button 28 is also provided on the control lever 7.

Another emergency stop button 29 is provided on the housing 2 above and in particular is colored red.

Because of the possibility of controlling the functions of the microtome 1 by means of the control lever 7 by pivoting the same and by actuating the buttons provided thereon, the advantage results that for controlling the microtome 1, only one hand is required, and the second hand remains free for removing one section from the contact area 12 of the knife carrier 6.

It is understood that instead of the embodiment that is shown in the drawings, which is designed for actuating the control lever 7 with the right hand, an embodiment is also possible in which the control lever 7 is arranged for actuation by the left hand. This is carried out simply by a mirror-image design of the microtome 1 of the embodiment shown in FIGS. 1 to 5.

In summary, an embodiment of the invention can be described as follows:

The preparation holding device 5 of a microtome 1 can be pivoted via a ball head 15. To pivot the preparation holding device 5, actuators are assigned to the latter as drives 8, 9. A camera 16 and laser diodes 17 are arranged on the knife carrier 6 of the microtome 1 to detect the shape and positions of the preparation 10.

1. Microtome (1) for producing sections with a preparation holding device (5), with a knife carrier (6) with a knife (11), and with operating elements for the adjustment of the microtome (1) and for the actuation of the microtome (1) when implementing cutting processes, wherein at least the means (16, 17) that detect the position of the preparation are assigned to the preparation holding device (5), and wherein a drive (8, 9) for adjusting the preparation holding device (5) is assigned to the preparation holding device (5).

2. Microtome according to claim 1, wherein the means comprise a camera (16) that detects the preparation (10) in the preparation holding device (5).

3. Microtome according to claim 1, wherein the means comprise multiple laser diodes (17) that scan the preparation (10) in the preparation holding device (5).

4. Microtome according to claim 3, wherein the scanning planes of the laser diodes (17) are oriented in planes that are different from one another.

5. Microtome according to claims 3, wherein the data on the shape and position of the preparation (10) detected by the camera (16) and the laser diodes (17) are stored, and the control of the drives (8, 9) is assigned.

6. Microtome according to claim 1, wherein the preparation holding device (5) is held via a ball head (15).

7. Microtome according to claim 1, wherein the means, in particular the camera (16) and the laser diodes (17), are arranged on the side of the knife carrier (6) that faces the preparation holding device (5).

8. Microtome according to claim 7, wherein when detecting the shape and position of the preparation (10), the preparation holding device (5) is lowered into a position that is opposite to the knife carrier (6).

9. Microtome according to claim 8, wherein the preparation holding device (5) is raised and lowered.

10. Microtome according to claim 2, wherein the means comprise multiple laser diodes (17) that scan the preparation (10) in the preparation holding device (5).

11. Microtome according to claims 4, wherein the data on the shape and position of the preparation (10) detected by the camera (16) and the laser diodes (17) are stored, and the control of the drives (8, 9) is assigned.

12. Microtome according to claim 2, wherein the preparation holding device (5) is held via a ball head (15).

13. Microtome according to claim 3, wherein the preparation holding device (5) is held via a ball head (15).

14. Microtome according to claim 4, wherein the preparation holding device (5) is held via a ball head (15).

15. Microtome according to claim 5, wherein the preparation holding device (5) is held via a ball head (15).

16. Microtome according to claim 2, wherein the means, in particular the camera (16) and the laser diodes (17), are arranged on the side of the knife carrier (6) that faces the preparation holding device (5).

17. Microtome according to claim 3, wherein the means, in particular the camera (16) and the laser diodes (17), are arranged on the side of the knife carrier (6) that faces the preparation holding device (5).

18. Microtome according to claim 4, wherein the means, in particular the camera (16) and the laser diodes (17), are arranged on the side of the knife carrier (6) that faces the preparation holding device (5).

19. Microtome according to claim 5, wherein the means, in particular the camera (16) and the laser diodes (17), are arranged on the side of the knife carrier (6) that faces the preparation holding device (5).

20. The microtome of claim 9, wherein the preparation holding device is raised and lowered multiple times.
